(19) United States
(12) Patent Application Publication
(10) Pub. No.: US 2021/0237369 A1
(43) Pub. Date: Aug. 5, 2021

(54) ENERGY CONVERTING FILMS AND ASSEMBLIES INCLUDING THE SAME

(71) Applicant: Raven Industries, Inc., Sioux Falls, SD (US)

(72) Inventor: Steven G. Redford, Brandon, SD (US)

(21) Appl. No.: 17/263,498

(22) PCT Filed: Sep. 25, 2018
(86) PCT No.: PCT/US2018/052648

§ 371 Date: Jan. 26, 2021

(51) Int. Cl. B29C 65/00

(52) U.S. Cl. CPC B29C 66/712; B29C 66/1122; B29C 65/4815; B29C 66/723; B29C 66/73921

(57) ABSTRACT

Various embodiments disclosed relate to an energy converting film. The energy converting film comprises a polymer component. The energy converting film further comprises a susceptor component at least partially distributed in the polymer component.

### BACKGROUND

Polymeric films can be used as a chemical barrier or liner. Under certain circumstances, a film may need to cover a large area. However, it can be difficult to produce a film that can cover the area by itself, therefore multiple films may need to be joined to properly cover the area. Joining films together can result in gaps between the films that compromise the ability of the film to perform as an effective barrier. There is therefore a need to produce film that a capable of being joined and serving as a barrier.

### SUMMARY OF THE DISCLOSURE

The present disclosure provides an energy converting film. The energy converting film comprises a polymer component. The energy converting film further comprises a susceptor component at least partially distributed in the polymer component or that is part or the polymer component.

The present disclosure further provides a welded product of an energy converting film. The energy converting film comprises a polymer component. The energy converting film further comprises a susceptor component at least partially distributed in the polymer component or that is part or the polymer component.

The present disclosure further provides a weldable assembly. The weldable assembly includes a first polymeric film and an optional second polymeric film. The weldable assembly further includes an energy converting film in contact with the first polymeric film and the second polymeric film. The energy converting film comprises a polymer component. The energy converting film further comprises a susceptor component at least partially distributed in the polymer component or that is part or the polymer component.

The present disclosure further provides a welded assembly. The welded assembly includes an induction-welded product of a weldable assembly including an energy converting film in contact with a first polymeric film and a second polymeric film. The energy converting film comprises a polymer component. The energy converting film further comprises a susceptor component at least partially distributed in the polymer component or that is part or the polymer component.

The present disclosure further provides a method of making a welded assembly. The welded assembly includes an induction-welded product of a weldable assembly including an energy converting film in contact with a first polymeric film and a second polymeric film. The energy converting film comprises a polymer component. The energy converting film further comprises a susceptor component at least partially distributed in the polymer component. The method includes contacting the first polymeric film and the second polymeric film with the energy converting film. The method further includes exposing the first polymeric film, the second polymeric film, and the energy converting film to a source of electromagnetic radiation. The method further includes welding the energy converting film to the first polymeric film and the second polymeric film.

The present disclosure further includes a tubular film including a weldable assembly. The weldable assembly includes a first polymeric film and an optional second polymeric film. The weldable assembly further includes an energy converting film in contact with the first polymeric film and the second polymeric film. The energy converting film comprises a polymer component. The energy converting film further comprises a susceptor component at least partially distributed in the polymer component.

The present disclosure further includes a joined tubular films including a welded assembly including an induction-welded product of a weldable assembly including an energy converting film in contact with a first polymeric film and a second polymeric film. The energy converting film comprises a polymer component. The energy converting film further comprises a susceptor component at least partially distributed in the polymer component.

### BRIEF DESCRIPTION OF THE FIGURES

The drawings illustrate generally, by way of example, but not by way of limitation, various embodiments discussed in the present document.

FIG. 1 is a schematic view of a weldable assembly, in accordance with various embodiments.

FIG. 2 is a schematic view of another weldable assembly, in accordance with various embodiments.

FIG. 3 is a schematic view of another weldable assembly, in accordance with various embodiments.

FIG. 4 is a schematic view of another weldable assembly, in accordance with various embodiments.

FIG. 5 is a schematic view of another weldable assembly, in accordance with various embodiments.

FIG. 6 is a schematic view of another weldable assembly, in accordance with various embodiments.

FIG. 7 is a schematic view of another weldable assembly, in accordance with various embodiments.

FIG. 8 is a schematic view of another weldable assembly, in accordance with various embodiments.

FIG. 9A is a schematic view of another weldable assembly, in accordance with various embodiments.

FIG. 9B is a schematic view of another weldable assembly, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substituted” as used herein in conjunction with a molecule or an organic group as defined herein refers to the state in which one or more hydrogen atoms contained therein are replaced by one or more non-hydrogen atoms.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃), —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

According to various embodiments of the present disclosure, an energy converting film includes a polymer component and a susceptor component. The susceptor component can be at least partially distributed in the polymer component. The energy converting film is adapted to be weldable by converting electromagnetic energy into heat. The welding apparatus contains an induction coil that is energized with a alternating electric current. This generates a alternating electromagnetic field that acts on either an electrically conductive or a ferromagnetic susceptor. In an electrically conductive susceptor, the main heating effect is resistive heating, which is due to induced currents called eddy currents. In a ferromagnetic susceptor, the heating is caused mainly by hysteresis, as the electromagnetic field repeatedly distorts the magnetic domains of the ferromagnetic material. In practice, most materials undergo a combination of these two effects.

Nonmagnetic materials and electrical insulators such as plastics can be induction-welded by implanting them with metallic or ferromagnetic susceptor that absorb the electromagnetic energy from the induction coil, become hot, and lose their heat to the surrounding material by thermal conduction. Plastic can also be induction welded by embedding the plastic with electrically conductive fibers like metals or carbon fiber. Induced eddy currents resistively heat the embedded fibers which lose their heat to the surrounding plastic by conduction. The depth that the currents, and therefore heating, penetrates from the surface is inversely proportional to the square root of the frequency. The temperature of the metals being welded and their composition will also affect the penetration depth. This process is very similar to resistance welding, except that in the case of resistance welding the current is delivered using contacts to the workpiece instead of using induction. Polar plastics can be welded with high frequency fields greater than 10 MHz depending on the plastic. This method of heating is created from vibrations of the polar molecules when the exposure to the high frequencies.

Materials included in the energy converting film are chosen from those that are compatible with induction welding. For example, the polymer component of the energy converting film can include any suitable polymer or mixture of polymers. For example, the energy converting film can include a thermoplastic polymer, a thermoset polymer, or a mixture thereof. According to various embodiments the thermoplastic polymer can be a polyamide-imide, a polyethersulphone, a polyetherimide, a polyarylate, a polysulphone, a polymethacrylate, a polyvinylchloride, an acrylonitrile butadiene styrene, a polystyrene, a polyetherimide, copolymers thereof, or a combination thereof. According to various embodiments, the thermoset polymer can be a polyphenylene ether, a nylon 6,6, a nylon 11, a polyphenylene sulphide, a polyethylene terephthalate, a polyoxymethylene, a polypropylene, a high-density polyethylene, a low-density polyethylene, a chlorinated sulfur polyethylene, or a combination thereof.

In embodiments where the polymer component includes a polyethylene, suitable examples include metallocene polyethylene copolymers, ethylene vinyl acetate copolymer, ethylene/acrylic acid copolymers. Where the polymer is a polyethylene, the polyethylene can be characterized by its density. In some embodiments, the polyethylene can be a very low-density polyethylene (VLDPE) such as a polymer available under the trade designation “INFUSE 9507” from Dow, Midland, Mich.; a low-density polyethylene (LDPE) such as a polymer available under the trade designation “PETROTHENE NA217000” from LyondellBasell, Rotterdam Netherlands; linear low-density polyethylene (LLDPE) such as a polymer available from DOWLEX 2045G from Dow, Midland, Mich. or a high-density polyethylene (HDPE) such as a polymer available under the trade designation “DOW ELITE 5960G” from Dow. In some embodiments, the density of the VLDPE, is in a range from 0.80 g/cm³ to 0.86 g/cm³, or from 0.81 g/cm³ to 0.85 g/cm³, or from 0.82 g/cm³ to 0.84 g/cm³). In some embodiments, the density of the LLDPE or LDPE is in a range from 0.90 g/cm³ to 0.92 g/cm³, or from 0.90 g/cm³ to 0.91 g/cm³. In some embodiments, the density of the HDPE is in a range, for example, from 0.92 g/cm³ to 0.96 g/cm³, or from 0.93 g/cm³ to 0.95 g/cm³.

A melting point of the polymer component can be any suitable value. For example, the melting point can be in a range of from about 10° C. to about 500° C. about 50° C. to about 350° C., about 100° C. to about 200° C., less than, equal to, or greater than about 10° C., 20, 30, 40, 50, 60, 70, 80, 90, 100, 110, 120, 130, 140, 150, 160, 170, 180, 190, 200.210, 220, 230, 240.250, 260, 270, 280, 290, 300, 310, 320, 330, 340, 350, 360, 370, 380, 390, 400, 410, 420, 430, 440, 450, 460, 470, 480, 490, or about 500° C.

The energy converting film can include a mixture of polymers. For example, the polymer component can include a first polymer, a second polymer, a third polymer, or any plural number of polymers. In embodiments where the polymer component includes multiple polymers, those polymers can differ by composition, weight-average molecular weight, melting point glass transition temperature, color, or a combination thereof. The different polymers can be homogenously distributed throughout the energy converting film.

Alternatively, different polymers can be distributed through the energy converting film in a heterogenous manner. For example, in embodiments of the energy converting film that include three different polymers, a first polymer can be dispersed in a first discrete region of the energy converting film, the second polymer can be dispersed in a second discrete region of the energy converting film that is adjacent to the first region, and the third polymer can be dispersed in a third discrete region of the energy converting film adjacent to the second region. Each region can account for a different wt % of the energy converting film. For example, each region can independently comprise from about 5 wt % to about 70 wt % of the energy converting film, about 20 wt % to about 50 wt %, about 25 wt % to about 33 wt %, less than, equal to, or greater than about 5 wt %, 10, 15, 20, 25, 30, 35, 40, 45, 50, 55, 60, 65, or about 70 wt %.

In some embodiments, the energy converting film can include a plurality of layers of the polymeric component, each including the susceptor component. In examples where the energy converting film includes a plurality of layers the polymeric component of each layer can be the same component or mixture of components. The number of layers can be in range of from 2 to 20, 10 to 15, less than, equal to, or greater than 2, 3, 4, 5, 6, 7, 8, 9, 10, 11, 12, 13, 14, 15, 16, 17, 18, 19, or 20 layers. Although up to 20 layers are described, the energy converting film can include any plural number of layers.

The susceptor component is dispersed throughout the polymer component. For example, the susceptor component can be dispersed throughout the polymer component in a homogenous manner or a heterogenous manner. The susceptor component can include any material or materials that are capable of locally generating heat upon exposure to electromagnetic radiation such as an electrically-conductive material, a ferromagnetic material, or a mixture thereof. Examples of suitable materials of the susceptor component can include a metal, a plastic, a ceramic, a carbon, or a mixture thereof. Examples of metals include iron, copper, aluminum, nickel, cobalt, carbon steel, alloys thereof, or mixtures thereof. In some embodiments, the metal comprises stainless steel. In various embodiments the stainless steel may be magnetic or non-magnetic. The stainless steel can be a 300 series stainless steel, a 304 series stainless steel, a 400 series stainless steel, or a mixture thereof. Examples of carbon include a carbon nanotube, a conductive carbon, or a mixture thereof. Examples of ceramics include a silicon carbide. Examples of suitable plastics include a polar plastic. Examples of suitable polar plastics include a polyamide, a polycarbonate, a poly(methyl methacrylate), an acrylonitrile butadiene styrene, a polyvinyl chloride, a polyketone, an ethylene-vinyl acetate, or a combination thereof. In cases where the susceptor component comprises a polar plastic the polymeric material of weldable film 102 can be entirely made of the polar plastic such that weldable film 102 comprises 100 wt % polar plastic.

The material of components of the susceptor component can be chosen from materials that are configured to generate heat upon exposure to a frequency in a range of from about 60 Hz to about 100 MHz, about 200 KHz to about 10 MHz, less than, equal to, or greater than about 60 Hz, 100 Hz, 500 Hz, 1.000 Hz, 50,000 Hz, 100,000 Hz, 150,000 Hz, 200,000 Hz, 250.000 Hz, 300,000 Hz, 350,000 Hz, 400,000 Hz, 450,000 Hz, 500,000 Hz, 600,000 Hz, 650.000 Hz, 700,000 Hz, 750,000 Hz, 800.000 Hz, 850.000 Hz, 900,000 Hz, 950,000 Hz, 1,000,000 Hz, 5 MHz, 10 MHz, 15 MHz, 20 MHz, 25 MHz, 30 MHz, 35 MHz, 40 MHz, 45 MHz, 50 MHz, 55 MHz, 60 MHz, 65 MHz, 70 MHz, 75 MHz, 80 MHz, 85 MHz, 90 MHz, 95 MHz, or about 100 MHz.

The susceptor component can be present as a continuous structure or as a plurality of discrete structures. For example, the susceptor component can be present as a collection of fibers, particles, flakes, or mixtures thereof. The dimensions of the individual susceptor components can be any suitable value. For example, a thickness of any flake or a largest diameter of any fiber or particle can independently be in a range of from about 10 nm to about 25 μm, about 15 nm to about 10 μm, about 500 nm to about 1 μm, less than, equal to, or greater than about 10 nm, 50 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, or about 25 μm.

In embodiments where the susceptor component includes a continuous screen, the screen can be fully embedded into the polymeric component or partially embedded into the polymer component. The screen can be a solid structure or can be a perforated structure.

The susceptor can be present in the in energy converting film in any suitable concentration. For example the susceptor can be in a range of from about 0.1 wt % to about 50 wt % of the energy converting film, about 10 wt % to about 20 wt %, about 13 wt % to about 15 wt %, less than, equal to, or greater than about 0.1 wt %, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, or about 80 wt %. When disposed in the polymeric component, the susceptor component can be in a range of form about 5 vol % to about 40 vol %, about 20 vol % to about 30 vol %, less than, equal to, 5 vol %, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, or about 40 vol % In some further embodiments the susceptor component can about for 100 wt % of the energy converting film. In those embodiments, the polymeric component would be 100 wt % susceptor component.

The energy converting film can assume any suitable shape or configuration. For example, the energy converting film can assume a flat and substantially planar shape. In further embodiments, the energy converting film can assume a generally cylindrical shape. In further embodiments, the energy converting film can assume a polygonal shape such as a triangle, a square, a rectangle, a pentagon, or any other suitable hollow polygonal shape. The thickness of the shapes can be uniform or variable. An example of a variable shape can be a hollow dumbbell shape.

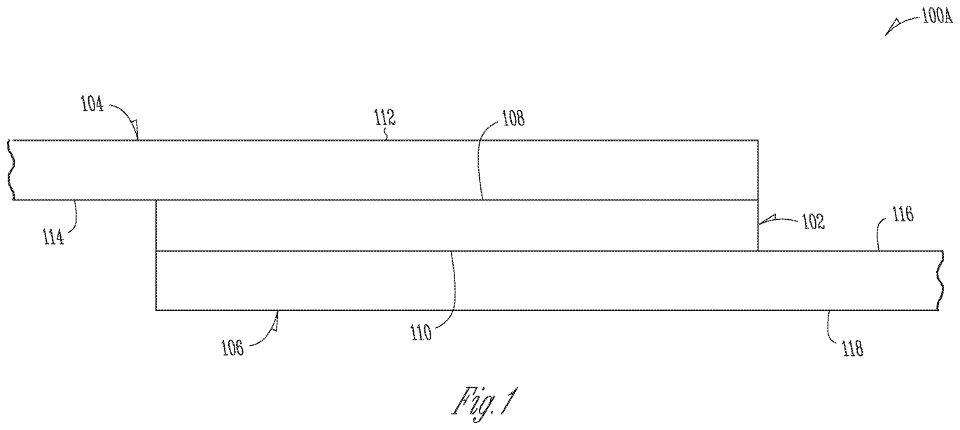

The energy converting film can be incorporated into an assembly. FIGS. 1-8 are schematic diagrams of various assemblies including the energy converting film. FIGS. 1-8 show many similar concepts and are discussed concurrently. As shown in FIG. 1, assembly 100A includes energy converting film 102, first polymeric film 104, and second polymeric film 106. As shown in FIG. 1, energy converting film 102 includes first major surface 108 and opposite second major surface 110. First polymeric film 104 includes third major surface 112 and opposite fourth major surface 114. Second polymeric film 106 includes fifth major surface 116 and opposite sixth major surface 118. Energy converting film 102 is in contact with first polymeric film 104 and second polymeric film 106, in some embodiments, energy converting film 102 can be coextruded with first polymeric film 104, second polymeric film 106, or both.

Assembly 100A can have any suitable thickness. For example, a thickness of assembly 100A can be in a range of from about 0.0005 micrometers to about 5 mm, about 1 mm to about 4 mm, less than, equal to, or greater than about 0.0005 micrometers, 0.001 micrometers, 0.01 micrometers, 1 micrometer, 10 micrometers, 100 micrometers, 500 micrometers, 1,000 micrometers, 0.01 mm, 0.1 mm, 0.5 mm, 1 mm, 1.5 mm, 2 mm, 2.5 mm, 3 mm, 3.5 mm, 4 mm, 4.5 mm, or about 5 mm.

First polymeric film 104 and second polymeric film 106, taken together, can form a chemically resistant layer. The chemically resistant layer can be used a liner. For example, the liner can be a pipe liner. Including energy converting film 102, can be helpful in sealing a gap between first polymeric film 104 and second polymeric film 106 such that the liner is a continuous structure.

First polymeric film 104 and second polymeric film 106 can include a material or combination of materials that are resistant to degradation or penetration by a solution including a substituted or unsubstituted (C₁-C₅₀)hydrocarbyl. For example, first polymeric film 104 and second polymeric film 106, can be resistant to degradation or penetration by a solution including fuel or oil. Furthermore, first polymeric film 104 and second polymeric film 106 can be resistant to degradation or penetration by an acidic solution having a pH in a range of from about 0 to about 4, about 1 to about 3, less than, equal to, or greater than about 0, 1, 2, 3, or about 4. Moreover, first polymeric film 104 and second polymeric film 106 can be resistant to degradation or penetration by an alkaline solution having a pH in a range of from about 10 to about 14, about 11 to about 13, less than, equal to, or greater than about 10, 11, 12, 13, or about 14.

Examples of suitable materials for first polymeric film 104 and second polymeric film 106 can a polyolefin, a polyurethane, a polyester or a combination thereof. First polymeric film 104 and second polymeric film 106 can include the same material or combination of materials. In further embodiments of assembly 100A, first polymeric film 104 and second polymeric film 106 can include a different material or combination of materials.

First polymeric film 104 and second polymeric film 106 can have a monolayer structure. Alternatively, first polymeric film 104, second polymeric film 106, or both can be multi-layer structures. In embodiments, in which first polymeric film 104, second polymeric film 106, or both are multi-layer structures, each film can include any plural number of layers. For example, each multi-layer structure can independently include from about 2 layers to about 15 layers, about 4 layers to about 6 layers, less than, equal to, or greater than about 2 layers, 3, 4, 5, 6, 7, 8, 9, 10, 11, 12, 13, 14, or about 15 layers. Again, either of first polymeric film 104 or second polymeric film 106 can include any plural number of layers. For example, it is possible to create films that include hundreds or thousands of individual layers. In embodiments of assembly 100A where first polymeric film 104, second polymeric film 106, or both are multi-layer structures, each layer can include the same material or mixture of materials. In further embodiments where first polymeric film 104, second polymeric film 106, or both are multi-layer structures, each layer, or at least two layers, can include a different material or combination of materials.

Assembly 100A can be attached a substrate. For example, energy converting film 102 can be attached to a plastic or metal substrate. The substrate can have any shape. For example, the substrate can be cylindrically shaped. The substrate can also be shaped to have any other polygonal profile such a triangle, square, rectangle, pentagon, hexagon, heptagon. In some embodiments, assembly 100A can be disposed between two substrates. For example, first polymeric film 104 can be attached to a first substrate and second polymeric film 106 can be attached a to a second substrate. The attachment between assembly 100A and either substrate be through any suitable method. For example, assembly 100A and either substrate or both can be through and adhesive layer, a weld, or both. In embodiments in which assembly 100A and the substrate are joined by an adhesive layer, the adhesive layer can include a thermoplastic adhesive. An example of a suitable thermoplastic adhesive includes maleic anhydride.

As described herein, energy converting film 102 is configured to be welded to first polymeric film 104 and second polymeric film 106 through induction welding. It is possible to weld assembly 100A such that the weld can be characterized according to a lap weld, a butt weld, or a prayer weld, although additional welds are possible. An example of assembly 100A including a lap weld is shown in FIG. 1. As shown in FIG. 1, the lap weld is formed by a connection between first surface 108 of energy converting film 102 and a portion of fourth surface 114 of first polymeric film 104 as well as a connection between second surface 110 of energy converting film 102 and fifth surface 116 of second polymeric film 106.

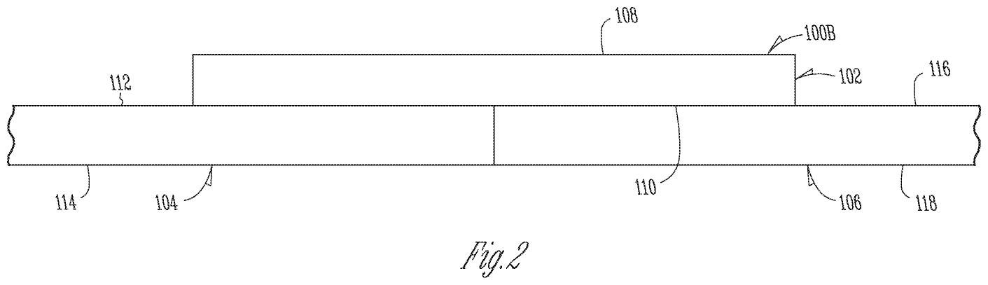

FIG. 2 shows an example of assembly 100B including a butt weld. As shown in FIG. 2, the butt weld is formed by a connection between a portion of second surface 110 of energy converting film 102 and a portion of third surface 112 of first polymeric film 104 as well as a portion of second surface 110 of energy converting film 102 and a portion of fifth surface 116 of second polymeric film 106. As shown in FIG. 2, first surface 108 of energy converting film is exposed, however in further embodiments first surface 108 can be covered with a backing or a liner. The backing or liner can include any suitable material or mixture of materials. For example, the backing or liner can include a polymeric film, a woven fabric, a knitted fabric, paper, vulcanized fiber, a staple fiber, a continuous fiber, a non-woven, a foam, a laminate, or a combination thereof. In some embodiments, the backing or liner can act as a susceptor in addition to a cover.

As shown in FIG. 2 first polymeric film 104 and second polymeric film 106 are in contact with each other along adjacent minor surfaces. Further an equal amount of energy converting film 102 is in contact with first polymeric film 104 as second polymeric film 106. However, in some embodiments, either of the portion of second surface 110 of energy converting film 102 in contact with the portion of third surface 112 of first polymeric film 104 or the portion of second surface 110 of energy converting film 102 and in contact with the portion of fifth surface 116 of second polymeric film 106 may be larger.

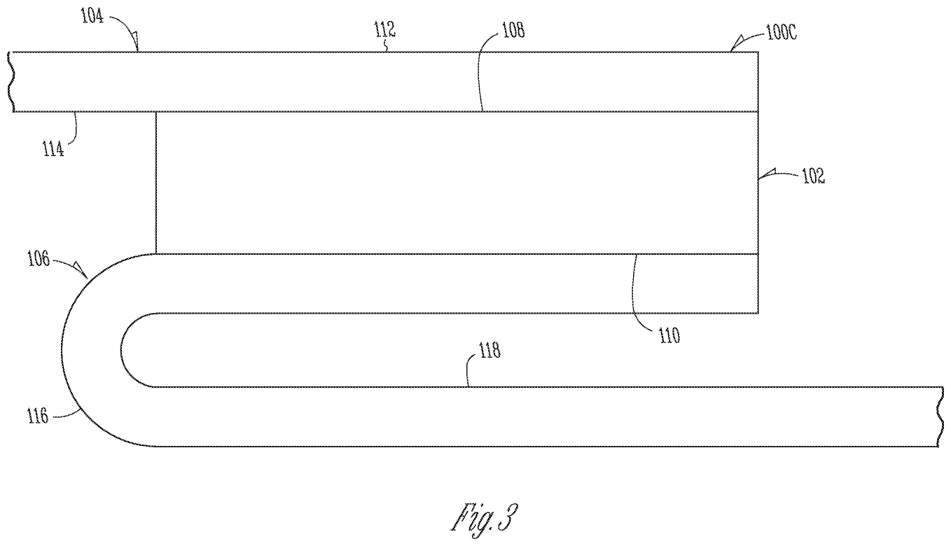

FIG. 3 shows an example of assembly 100C including a prayer weld. As shown in FIG. 3, the prayer weld is formed by a connection between a portion of first surface 108 of energy converting film 102 and fourth surface 114 of first polymeric film 104 as well as second surface 110 of energy converting film 102 and fifth surface 116 of second polymeric film 106. As further shown, second polymeric film 106 is folded such that a portion of sixth surface 118 faces itself.

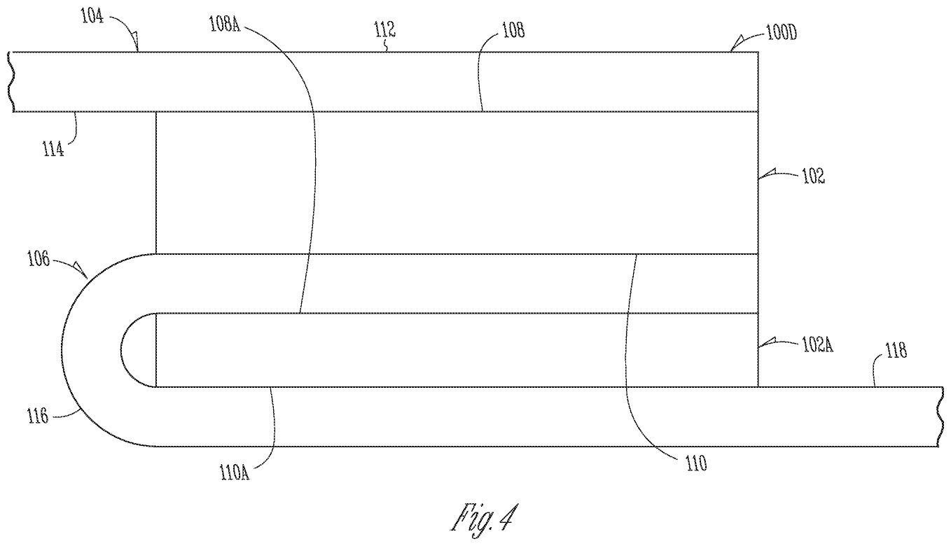

FIG. 4 shows an example of assembly 100D including a prayer weld as described with respect to FIG. 3, but also includes second energy converting film 102A. As shown, second energy converting film 102A is positioned between the folded portion of second polymeric film 106 such that first surface 108A and second surface 110A of energy converting film 102A is in contact with sixth surface 118 of second energy converting film 102A. Including second energy converting film 102A can be helpful to ensure that assembly 100D can sufficiently withstand axial stresses. Each energy converting film 102 can include the same material or combination of materials, which can be helpful to allow each film to be simultaneously welded. In further embodiments, each energy converting film can include different materials or combinations of materials. Using different materials can allow for each energy converting film to be selectively welded. For example, each energy converting film may respond to different frequencies.

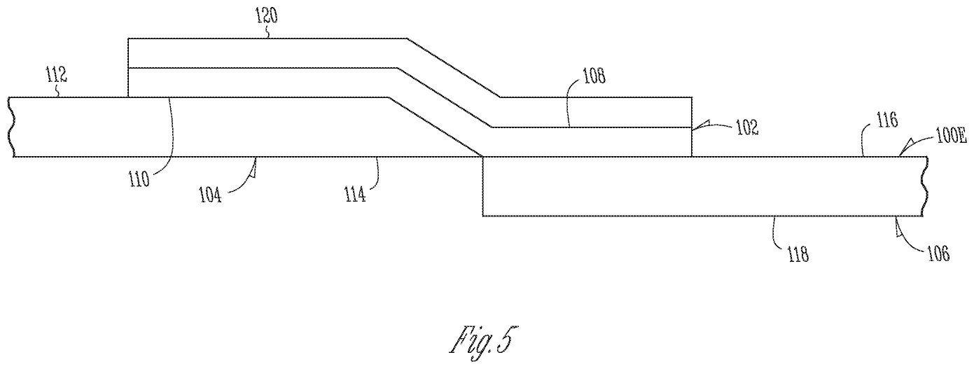

There many further suitable manners to join first polymeric film. For example, to form assembly 100E, as shown in FIG. 5, energy converting film 102 is applied such that second surface 110 of energy converting film 102 is in contact with third surface 112 of first polymeric film 104 and fifth surface 116 of second polymeric film 106. As shown, a portion of fourth surface 114 of first polymeric film 104 and fifth surface 116 of second polymeric film 106 are in contact to form an overlap joint. Backing 120 can be applied to first surface 108 of energy converting film 102.

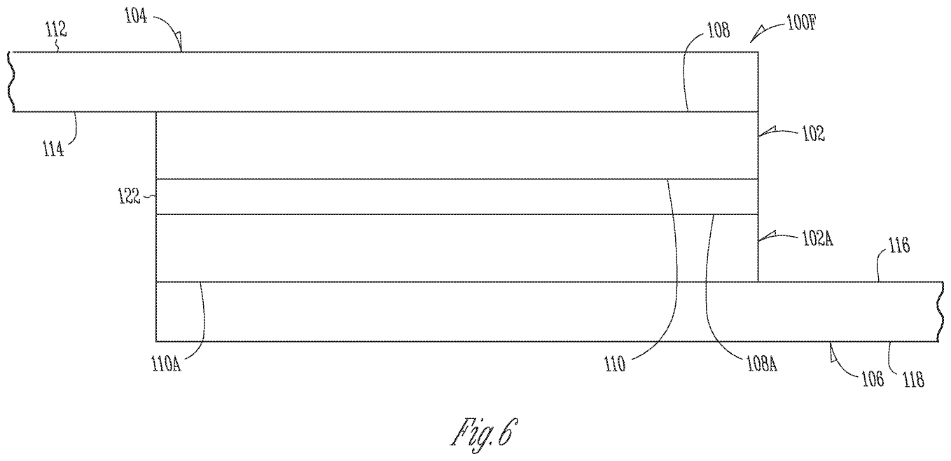

In some embodiments of assembly 100, it may not be possible to form energy converting film 102 from a material that is capable of forming a weld between the material or materials of first polymeric film 104 and the material or materials of second polymeric film 106. FIG. 6 shows an example of assembly 100F joined by a lap weld. As shown, assembly 100F includes first polymeric film 104, which is welded to first energy converting film 102. Polymeric assembly 100F further includes second energy converting film 102A, which is welded to second polymeric film 106. Although it may be possible to weld films 102 and 102A to each other, as shown films 102 and 102A are joined by adhesive layer 122. The material or materials of first energy converting film 102 are chosen from materials that are capable of being welded to the material or materials of first polymeric film 104. The material or materials of second energy converting film 102A are chosen from materials that are capable of being welded to the material or materials of second polymeric film 106.

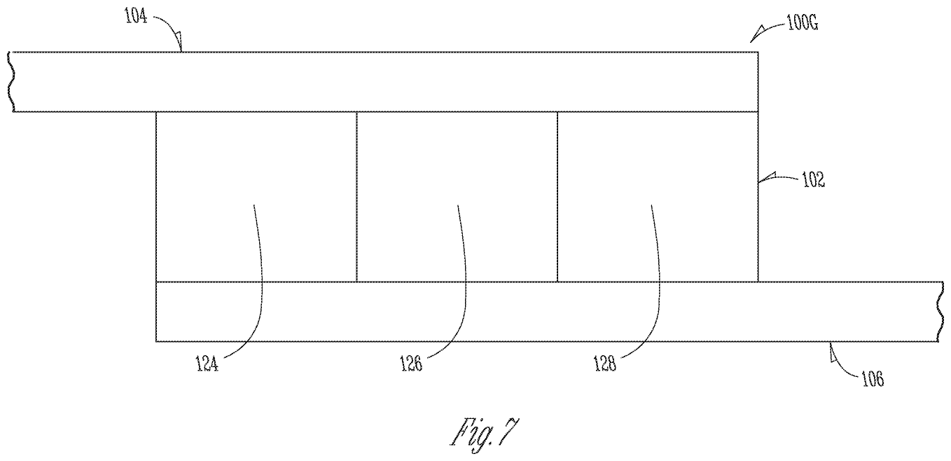

In further embodiments of assembly 100, where it may not be possible to form energy converting film 102 from a material that is capable of forming a weld between the material or materials of first polymeric film 104 and the material or materials of second polymeric film 106, energy converting film 102 can be formed to include a plurality of materials that are capable of being welded to the material or materials of first polymeric film 104 and second polymeric film 106, respectively. For example, FIG. 7 shows an embodiment of assembly 100G where energy converting film 102 includes first material 124, second material 126, and third material 128. Each of materials 124, 126, and 128 include a different material or mixture of materials. The selection of materials can be such that at least one of materials 124, 126, or 128 is capable of forming a weld with first polymeric film 104 while another of materials 124, 126, or 128 are capable of forming a weld with second polymeric film 106. In some embodiments, an interior material such as material 126 can be a reinforcement layer that can be used to hold materials such as materials 124 and 128 together. The reinforcing material can be any suitable material such as a fiber glass, a woven fabric, a knitted fabric, paper, vulcanized fiber, a staple fiber, a continuous fiber, a foam, a laminate, or a combination thereof. In some embodiments, the materials can be selected such that the combinations of materials can be used to weld to surfaces, which are not clean. For example, portions or the entirety of polymeric film 104 or 106 may have dust or some other contaminant disposed thereon. A contaminant such as dust may make it difficult to form a weld between weldable film 102 and films 104 or 106. But, any of materials 124, 126, or 128 can be chosen from materials that are capable of forming a weld on a surface that includes the contaminant.

This embodiment of energy converting film 102 can be helpful in joining first polymeric film 104 and second polymeric film 106 when each polymeric film includes one material. But this embodiment of energy converting film 102 can also be useful when either first polymeric film 104, second polymeric film 106, or both include a plurality of materials. For example, energy converting film 102 can be designed such that one of materials 124, 126, or 128 are capable of being welded to a plurality of materials of first polymeric layer 104, second polymeric layer 106, or both. Therefore, a weld can be formed across a plurality of materials. Although energy converting film 102 is shown as including three materials, it is possible for energy converting film 102 to include as few as two materials or any other plural number.

In some embodiments where energy converting film 102 includes a plural number of materials, the materials on the ends of energy converting film 102 (e.g., materials 124 and 128) can be chosen from materials that have a higher melting point than a material of the interior of energy converting film 102 (e.g., material 126). Therefore, if melting or welding of at least one of materials 124 and 128 it can be assumed that energy converting film 102 is welded because a temperature sufficient to melt materials 124 and 128 would be sufficient to melt material 126. To aide in visually confirming that materials 124 and 128 are welded or melted, materials 124, 128, or both can be colored (e.g., include a pigment component).

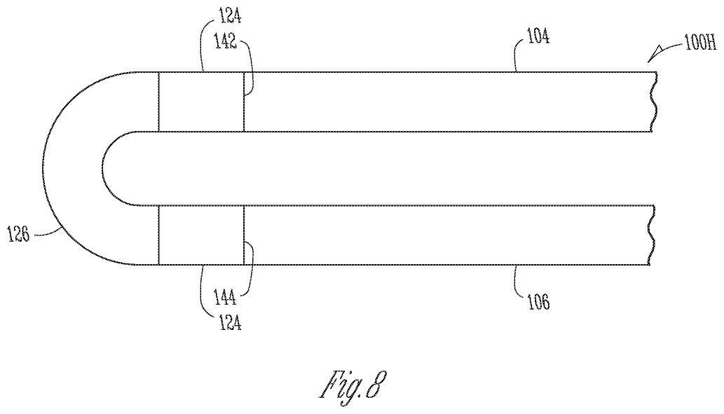

FIG. 8 shows another embodiment of weldable assembly 100H. As shown energy converting film 102 includes materials 124 and 126. Materials 124 are adapted to be welded to ends 142 and 144 of first polymeric layer 104 and second polymeric layer 106, respectively. Material 126 can be any suitable material and can include the same material or combination of materials of first polymeric layer 104, second polymeric layer 106, or both. Material 126 can be an elastic or flexible material that can help to facilitate alignment between first polymeric layer 104 and second polymeric layer 106.

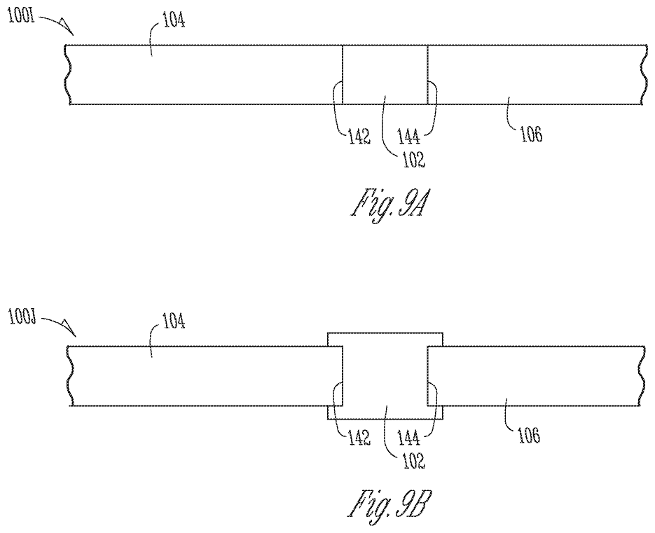

FIG. 9A shows another embodiment of weldable assembly 100I. Weldable assembly 100I of FIG. 9A is similar to that of FIG. 8 except that there are not distinct regions of materials (e.g., 124, 126, and 128). In FIG. 9A, energy converting film 102 is in direct contact with ends 142 and 144. FIG. 9B shows assembly 100J that is similar to assembly 100I of FIG. 9A except that energy converting film 102 includes overhangs 150, which overlap with a portion of surfaces 112, 114, 116, and 118 and are welded thereto. This can help to reinforce the weld to resist against axial or radial stresses. Although overhangs are shown with respect to assembly 100, these features can be incorporated into energy converting film of any assembly described herein.

Weldable assembly 100 can be formed according to many suitable methods. For example, first polymeric film 104 and second polymeric film 106 can be brought into contact with energy converting film 102. Brining those components into contact can include overlaying a portion of first polymeric film 104 and second polymeric film 106 to form an intersection therebetween. Energy converting film 102 can then applied be over the intersection. In some embodiments, energy converting film 102 can be compressed between first polymeric film 104 and second polymeric film 106.

Following contact first polymeric film 104, second polymeric film 106, and energy converting film 102 are to a source of electromagnetic radiation. The electromagnetic radiation can be chosen from a frequency described above. In some embodiments, it can be possible to the electromagnetic radiation can be provided by an induction welder. The induction welder can be any device that includes an induction coil that is capable of generating electromagnetic radiation.

The induction welder can be positioned proximate to any suitable location of assembly 100. For example, in some embodiments, assembly 100 can be located in an interior of an assembly of joined tubular films (e.g., a pipe). The induction welder can be positioned inside the pipe to allow for welding from the inside out. Additionally, it is possible to position the induction welder outside of the pipe and allow for the weldable assembly to be welded. This can be advantageous, for example, if a material of the external surface of the pipe could be melted or structurally compromised upon exposure to electromagnetic radiation.

The welds that can be formed through induction welding are superior to traditional welds that could be used to join polymeric films 104 and 106. Examples of traditional welds include extrusion welding, bar welding, hot air welding, or wedge welding. These traditional welding techniques can result in reducing the strength of a welded assembly, despite joining components of the assembly. The strength can be reduced by making materials thinner or in the case of extrusion welding, creating a weaker cold weld. Furthermore, induction welding allows for local heating on the weldable film, as opposed to the global heating of the assembly. The susceptors of weldable film 102, moreover, can be sensitive enough that an induction welder can be located on an external surface of an assembly, which can allow for weldable assembly 102 located on an internal surface to be heated. Additionally, the equipment required to induction weld film 102 are simple and portable enough to allow for welding in the field or in the factory. The ability to weld in the field is useful for assembly or for repair.

### Additional Embodiments

The following exemplary embodiments are provided, the numbering of which is not to be construed as designating levels of importance:

Embodiment 1 provides an energy converting film comprising:

a polymer component; and

a susceptor component at least partially distributed in the polymer component.

Embodiment 2 provides the energy converting film of Embodiment 1, wherein the polymer component comprises a thermoplastic polymer, a thermoset polymer, or a mixture thereof.

Embodiment 3 provides the energy converting film of Embodiment 2, wherein the thermoplastic polymer is a polyamide-imide, a polyethersulphone, a polyetherimide, a polyarylate, a polysulphone, a polymethacrylate, a polyvinylchloride, an acrylonitrile butadiene styrene, a polystyrene, a polyetherimide, or a combination thereof.

Embodiment 4 provides the energy converting film of any one of Embodiments 2 or 3, wherein the thermoset polymer is a polyphenylene ether, a nylon 6,6, a nylon 11, a polyphenylene sulphide, a polyethylene terephthalate, a polyoxymethylene, a polypropylene, a high-density polyethylene, a low-density polyethylene, a chlorinated sulfur polyethylene, or a combination thereof.

Embodiment 5 provides the energy converting film of any one of Embodiments 1-4, wherein the polymer component of the energy converting film comprises a polyolefin, a polyurethane, a polyester or a combination thereof.

Embodiment 6 provides the energy converting film of Embodiment 5, wherein the polyolefin is polypropylene, polyethylene, a copolymer thereof, or a combination thereof.

Embodiment 7 provides the energy converting film of Embodiment 6, wherein the polyethylene is a high-density polyethylene, a low-density polyethylene, a linear low-density polyethylene, or a combination thereof.

Embodiment 8 provides the energy converting film of any one of Embodiments 1-7, wherein the susceptor component comprises an electrically-conductive material, a ferromagnetic material, or a mixture thereof.

Embodiment 9 provides the energy converting film of any one of Embodiments 1-8, wherein the susceptor component comprises a metal, a plastic, a ceramic, a carbon, or a mixture thereof.

Embodiment 10 provides the energy converting film of Embodiment 9, wherein the metal comprises, iron, copper, aluminum, nickel, cobalt, carbon steel, alloys thereof, or mixtures thereof.

Embodiment 11 provides the energy converting film of Embodiment 9, wherein the carbon comprises a carbon nanotube, a conductive carbon, or a mixture thereof.

Embodiment 12 provides the energy converting film of Embodiment 9, wherein the metal comprises stainless steel.

Embodiment 13 provides the energy converting film of Embodiment 12, wherein the stainless steel is a 300 series stainless steel, a 304 series stainless steel, a 400 series stainless steel, or a mixture thereof.

Embodiment 14 provides the energy converting film of Embodiment 11, wherein the ceramic is silicon carbide.

Embodiment 15 provides the energy converting film of Embodiment 9, wherein the plastic is a polar plastic.

Embodiment 16 provides the energy converting film of Embodiment 15, wherein the polar plastic comprises a polyamide, a polycarbonate, a poly(methyl methacrylate), an acrylonitrile butadiene styrene, a polyvinyl chloride, a polyketone, an ethylene-vinyl acetate, or a combination thereof.

Embodiment 17 provides the energy converting film of any one of Embodiments 9-16, wherein the susceptor component comprises a fiber, a particle, a flake, or a mixture thereof.

Embodiment 18 provides the energy converting film of Embodiment 17, wherein a thickness of the flake or a largest diameter of the particle or fiber is independently in a range of from about 10 nm to about 25 μm.

Embodiment 19 provides the energy converting film of any one of Embodiments 17 or 18, wherein a thickness of the flake or a largest diameter of the particle is independently in a range of from about 0.1 μm to about 50 μm.

Embodiment 20 provides the energy converting film of any one of Embodiments 17-19, wherein a thickness of the flake or a largest diameter of the particle is independently in a range of from about 1 μm to about 25 μm.

Embodiment 21 provides the energy converting film of any one of Embodiments 17-20, wherein the susceptor component comprises a continuous screen.

Embodiment 22 provides the energy converting film of Embodiment 21, wherein the continuous screen is at least partially embedded in the polymer component.

Embodiment 23 provides the energy converting film of any one of Embodiments 1-22, wherein the susceptor component is homogenously distributed throughout the polymer component.

Embodiment 24 provides the energy converting film of any one of Embodiments 1-23, wherein the susceptor component is configured to generate heat upon exposure to a frequency in a range of from about 60 Hz to about 100 MHz.

Embodiment 25 provides the energy converting film of any one of Embodiments 1-24, wherein the susceptor component is configured to generate heat upon exposure to a frequency in a range of from about 200 KHz to about 10 MHz.

Embodiment 26 provides the energy converting film of any one of Embodiments 1-25, wherein the susceptor component is in a range of from about 0.1 wt % to about 80 wt % of the energy converting film.

Embodiment 27 provides the energy converting film of any one of Embodiments 1-26, wherein the susceptor component is in a range of from about 10 wt % to about 20 wt % of the energy converting film.

Embodiment 28 provides the energy converting film of any one of Embodiments 1-27, wherein the polymer component of the energy converting film comprises a first polymer component and a second polymer component.

Embodiment 29 provides the energy converting film of Embodiment 28, wherein the first polymer component and the second polymer component differ by composition, melting point glass transition temperature or a combination thereof.

Embodiment 30 provides the energy converting film of any one of Embodiments 28 or 29, wherein a first region of the energy convening film comprises the first polymer component and a second region of the first polymer component comprises the second polymer component.

Embodiment 31 provides the energy converting film of any one of Embodiments 28-30, wherein the first polymer component and the second polymer components are different colors.

Embodiment 32 provides the energy converting film of any one of Embodiments 28-31, further comprising a third polymer component.

Embodiment 33 provides the energy convening film of Embodiment 32, wherein the first polymer component, the second polymer component, and the third polymer component differ by composition, melting point, glass transition temperature, or a combination thereof.

Embodiment 34 provides the energy convening film of any one of Embodiments 32-33, further comprising a third region comprising the third polymer component.

Embodiment 35 provides the energy converting film of any one of Embodiments 1-34, wherein the energy converting film comprises a flat shape or a cylindrical shape.

Embodiment 36 provides the energy convening film of any one of Embodiments 1-35, further comprising an adhesive layer.

Embodiment 37 provides the energy converting film of any one of Embodiments 1-36, wherein the adhesive layer comprises a pressure sensitive adhesive.

Embodiment 38 provides a welded product of the energy convening film of any one of Embodiments 1-37.

Embodiment 39 provides a weldable assembly comprising:

a first polymeric film; and

an optional second polymeric film; and

the energy converting film of any one of Embodiments 1-34, wherein the energy converting film is in contact with the first polymeric film and the second polymeric film, the energy converting film.

Embodiment 40 provides the weldable assembly of Embodiment 39, wherein the energy converting film is at least partially embedded in the first polymeric film, the second polymeric film, or both.

Embodiment 41 provides the weldable assembly of any one of Embodiments 39 or 40, wherein the energy converting film is in contact with the first polymeric film and the second polymeric film.

Embodiment 42 provides the energy converting film of any one of Embodiments 39-41, wherein the first polymeric film, the second polymeric film, or both have a different composition.

Embodiment 43 provides the assembly of any one of Embodiments 39-42, wherein a thickness of the assembly is in a range of from about 0.0005 micrometers to about 5 mm.

Embodiment 44 provides the assembly of any one of Embodiments 39-43, wherein a thickness of the assembly is in a range of from about 1 mm to about 4 mm.

Embodiment 45 provides the assembly of any one of Embodiments 39-44, wherein the first polymeric film, the second polymeric film, or both, are multi-layer structures.

Embodiment 46 provides the assembly of Embodiment 45, wherein the first polymeric film, second polymeric film, or both, independently comprise from 2 to 15 layers.

Embodiment 47 provides the assembly of any one of Embodiments 45 or 46, wherein the first polymeric film, second polymeric film, or both, independently comprise from 4 to 6 layers.

Embodiment 48 provides the assembly of any one of Embodiments 45-47, wherein at least one layer of the first polymeric film comprises a different material than another layer of the first polymeric film; at least one layer of the second polymeric film comprises a different material than another layer of the second polymeric film; or both.

Embodiment 49 provides the assembly of Embodiment 48, wherein the first polymeric film, the second polymeric film, or both independently comprise a polyolefin, a polyurethane, a polyester or a combination thereof.

Embodiment 50 provides the assembly of any one of Embodiments 39-49, further comprising a backing attached to the energy converting film.

Embodiment 51 provides the assembly of Embodiment 50, wherein the backing comprises a polymeric film, a woven fabric, a knitted fabric, paper, vulcanized fiber, a staple fiber, a continuous fiber, a non-woven, a foam, a laminate, or a combination thereof.

Embodiment 52 provides the assembly of any one of Embodiments 39-51, further comprising a metal layer or a plastic layer attached to the first polymeric layer, the second polymeric layer, or both.

Embodiment 53 provides the assembly of Embodiment 52, wherein the metal or plastic layer is attached to the first polymeric layer, the second polymeric layer, or both by an adhesive layer, a weld, or both.

Embodiment 54 provides the assembly of Embodiments 53, wherein the adhesive layer comprises a thermoplastic adhesive.

Embodiment 55 provides the assembly of Embodiments 54, wherein the adhesive layer comprises a thermoplastic adhesive comprises maleic anhydride.

Embodiment 56 provides the assembly of any one of Embodiments 39-55, wherein the first polymeric film and the second polymeric film are chemically resistant layers.

Embodiment 57 provides the assembly of Embodiment 56, wherein the first polymeric film and the second polymeric film are resistant to degradation or penetration by a substance comprising a substituted or unsubstituted (C₁-C₅₀)hydrocarbyl, a solution having a pH in a range of from about 0 to about 4, a solution having a pH in a range of from about 10 to about 14, or a mixture thereof.

Embodiment 58 provides the assembly of any one of Embodiments 39-57, wherein a melting temperature of the energy converting film is higher than a melting temperature of the first polymeric film, the second polymeric film, or both.

Embodiment 59 provides the assembly of any one of Embodiments 39-58, wherein the energy converting film is at least partially wrapped about a cylindrical substrate.

Embodiment 60 provides the assembly of any one of Embodiments 39-59, wherein the energy converting film is disposed between an interior surface of first cylindrical substrate and an interior surface of a second cylindrical substrate.

Embodiment 61 provides the assembly of any one of Embodiments 36-60, wherein

the first polymeric film, the second polymeric film, and the polymeric component comprise linear low-density polyethylene; and

the susceptor component comprises stainless steel.

Embodiment 62 provides a welded assembly, comprising an induction-welded product of the assembly of Embodiments 39-61.

Embodiment 63 provides a method of making the welded assembly of Embodiment 62, the method comprising:

contacting the first polymeric film and the second polymeric film with the energy converting film;

exposing the first polymeric film, the second polymeric film, and the energy converting film to a source of electromagnetic radiation; and

welding the energy converting film to the first polymeric film and the second polymeric film.

Embodiment 64 provides the method of Embodiment 63, wherein during welding the first polymeric film, the second polymeric film, or both, melt to a lesser degree than the energy converting film.

Embodiment 65 provides the method of any one of Embodiments 63 or 64, further comprising compressing the energy converting film between the first polymeric film and the second polymeric film.

Embodiment 66 provides the method of any one of Embodiments 63-65, wherein the welding comprises using an induction welder comprising an induction coil.

Embodiment 67 provides the method of Embodiment 66, wherein the induction welder is located proximate to an exterior surface of a tubular film.

Embodiment 68 provides the method of any one of Embodiments 63-67, wherein the first polymeric film and the second polymeric film are joined by a lap weld, a butt weld, or a prayer weld.

Embodiment 69 provides the method of any one of Embodiments 63-68, wherein the first polymeric film and the second polymeric film are free of a void therebetween.

Embodiment 70 provides the method of any one of Embodiments 63-69, wherein contacting the first polymeric film and the second polymeric film with the energy converting film comprises:

overlaying a portion of the first polymeric film and the second polymeric film to form an intersection therebetween; and

applying the energy converting film over the intersection.

Embodiment 71 provides the method of any one of Embodiments 63-70, further comprising adhering the energy converting film to the first polymeric film, the second polymeric film, or both.

Embodiment 72 provides a method of induction welding plastics, comprising subjecting the weldable assembly of Embodiments 39-61 to RF frequency to generate a welded product thereof.

Embodiment 73 provides a tubular film comprising the weldable assembly of any one of Embodiments 39-61.

Embodiment 74 provides a tubular film comprising the welded assembly of any one of Embodiments 39-61.

1. An energy converting film comprising:
a polymer component; and
a susceptor component at least partially distributed in the polymer component.

2. The energy converting film of claim 1, wherein the polymer component comprises a thermoplastic polymer, a thermoset polymer, or a mixture thereof.

3. The energy converting film of claim 2, wherein the thermoplastic polymer is a polyamide-imide, a polyethersulphone, a polyetherimide, a polyarylate, a polysulphone, a polymethacrylate, a polyvinylchloride, an acrylonitrile butadiene styrene, a polystyrene, a polyetherimide, or a combination thereof.

4. The energy converting film of claim 2, wherein the thermoset polymer is a polyphenylene ether, a nylon 6,6, a nylon 11, a polyphenylene sulphide, a polyethylene terephthalate, a polyoxymethylene, a polypropylene, a high-density polyethylene, a low-density polyethylene, a linear low-density polyethylene, a chlorinated sulfur polyethylene, or a combination thereof.

5. The energy converting film of claim 1, wherein the polymer component of the energy converting film comprises a polyolefin, a polyurethane, a polyester or a combination thereof.

6. The energy converting film of claim 1, wherein the susceptor component comprises an electrically-conductive material, a ferromagnetic material, or a mixture thereof.

7. The energy converting film of claim 1, wherein the susceptor component comprises a metal, a plastic, a ceramic, a carbon, or a mixture thereof.

8. The energy converting film of claim 7, wherein the metal comprises, iron, copper, aluminum, nickel, cobalt, carbon steel, alloys thereof, or mixtures thereof.

9. The energy converting film of claim 8, wherein the carbon comprises a carbon nanotube, a conductive carbon, or a mixture thereof.

10. The energy converting film of claim 8, wherein the metal comprises stainless steel.

11. The energy converting film of claim 10, wherein the stainless steel is a 300 series stainless steel, a 304 series stainless steel, a 400 series stainless steel, or a mixture thereof.

12. The energy converting film of claim 7, wherein the ceramic is silicon carbide.

13. The energy converting film of claim 7, wherein the plastic is a polar plastic.

14. The energy converting film of claim 13, wherein the polar plastic comprises a polyamide, a polycarbonate, a poly(methyl methacrylate), an acrylonitrile butadiene styrene, a polyvinyl chloride, a polyketone, an ethylene-vinyl acetate, or a combination thereof.

15. The energy converting film of claim 1, wherein the susceptor component comprises a fiber, a particle, a flake, or a mixture thereof.

16. The energy converting film of claim 15, wherein a thickness of the flake or a largest diameter of the particle or fiber is independently in a range of from about 10 nm to about 25 μm.

17. The energy converting film of claim 1, wherein the susceptor component is configured to generate heat upon exposure to a frequency in a range of from about 60 Hz to about 100 MHz.

18. The energy converting film of claim 1, wherein the susceptor component is configured to generate heat upon exposure to a frequency in a range of from about 200 KHz to about 10 MHz.

19. The energy converting film of claim 1, wherein the susceptor component is in a range of from about 0.1 wt % to about 80 wt % of the energy converting film.

20. A welded product of the energy converting film of claim 1.

21. A weldable assembly comprising:
a first polymeric film; and
an optional second polymeric film; and
the energy converting film of claim 1, wherein the energy converting film is in contact with the first polymeric film and the second polymeric film, the energy converting film.

22. The assembly of claim 21, wherein the first polymeric film, the second polymeric film, or both independently comprise a polyolefin, a polyurethane, a polyester or a combination thereof.

23. The assembly of any one of claim 21, wherein the first polymeric film, the second polymeric film, or both, are multi-layer structures.

24. A method of making a welded assembly of the weldable assembly of any one of claim 21, the method comprising:
contacting the first polymeric film and the second polymeric film with the energy converting film;
exposing the first polymeric film, the second polymeric film, and the energy converting film to a source of electromagnetic radiation; and
welding the energy converting film to the first polymeric film and the second polymeric film.

25. The method of claim 24, wherein during welding the first polymeric film, the second polymeric film, or both, melt to a lesser degree than the energy converting film.

26. The method of claim 24, further comprising compressing the energy converting film between the first polymeric film and the second polymeric film.

27. The method of claim 24, wherein the welding comprises using an induction welder comprising an induction coil.

28. The method of claim 27, wherein the induction welder is located proximate to an exterior surface of a tubular and the energy converting film is located proximate to an interior surface of the tubular assembly.

29. The method of claim 24, wherein the first polymeric film and the second polymeric film are joined by a lap weld, a butt weld, or a prayer weld.

30. The method of claim 24, wherein the first polymeric film and the second polymeric film are free of a void therebetween.

31. The method of claim 24, wherein contacting the first polymeric film and the second polymeric film with the energy converting film comprises:
overlaying a portion of the first polymeric film and the second polymeric film to form an intersection therebetween; and
applying the energy converting film over the intersection.
